(19) United States
(12) Patent Application Publication
(10) Pub. No.: US 2017/0293992 A1
(43) Pub. Date: Oct. 12, 2017

(54) IMAGE CODE FOR PROCESSING INFORMATION AND DEVICE AND METHOD FOR GENERATING AND PARSING SAME

(71) Applicant: NANJING WATERMARKING TECHNOLOGY CO., LTD., Nanjing (CN)

(72) Inventors: Zheng Liu, Fuzhou (CN); Shiqiao Du, Fuzhou (CN)

(21) Appl. No.: 15/508,008

(22) PCT Filed: Aug. 25, 2015
(86) PCT No.: PCT/CN2015/088043

§ 371 Date: Mar. 1, 2017

(30) Foreign Application Priority Data
Oct. 13, 2014 (CN) 201410538071.7
Apr. 16, 2015 (CN) 201510180423.0

(51) Int. Cl. G06T 1/00; G06K 19/06

(52) U.S. Cl. CPC G06T 1/0028; G06K 19/06037; G06T 1/0007; G06T 2201/0203; G06T 2201/0053

(57) ABSTRACT

An image code is for information storage, transfer and identification, a method of generating and analyzing the same, and an apparatus for implementing the method, the image code includes a standard image area, at least one image filled in the standard image region, at least one segment of information stream implanted in the at least one image by using digital watermarking technique and 4 location identification graphics arranged in different positions of the standard image region, the location identification graphics are arranged in the 4 vertex angles of the standard image region, including 1 feature location identification graphic and 3 basic location identification graphics; the 3 basic location identification graphics are identical and the feature location identification graphic is different from the basic location identification graphic.

This application is the U.S. national phase of International Application No. PCT/CN2015/088043 filed on 25 Aug. 2015 which designated the U.S. and claims priority to Chinese Application CN201410538071.7 and CN201510180423.0 filed on 13 Oct. 2014 and 16 Apr. 2015, respectively, the entire contents of each of which are hereby incorporated by reference.

### TECHNICAL FIELD

The present invention relates to the image processing and automatic identification field, more particularly, to an image code for information processing and an apparatus and a method of generating and analyzing the same.

### BACKGROUND

With the advent of the mobile Internet era, two-dimensional code has gradually become the smart phone keyboard, the Internet access side, and is widely used in various fields of society and our daily lives. However, the existing two-dimensional code can not be intuitive or initial display of the information contained, often need additional text; and its black and white pattern is dull and mechanical, not beautiful, and without uniform sense of coordination with beautiful posters, business cards, and high-end merchandise packaging. In order to make the appearance of the two-dimensional code more elegant and dignified, the patent application CN 103632182 A proposed a three-dimensional image code generating and analyzing method, the method uses part regions in the central part of the two-dimensional code as the image region for display pictures related to the two-dimensional code contents, and uses boxes in 4 colors to replace the black and white box of the two-dimensional code. This method improves the aesthetical problem of two-dimensional code to a certain extent, but it is not much different from the black-and-white two-dimensional code in essence.

The digital watermarking technology can embed the information associated with the image in the image by image coding software without damaging the quality of the electronic image (also called an embedding process of the watermarking information), to form electronic watermarking information. Meanwhile, the electronic watermarking information embedded in the image can be read through the image decoding software (also called a detecting process of the watermarking information). The embedded electronic watermarking information is difficult to be tampered with or forged, so that the traditional digital watermarking technology is usually used to protect the copyright of electronic image. With the development of the digital watermarking technology and smart phone technology, the current digital watermarking technology has developed to detect the watermarking information embedded in the image through taking pictures of the printed image embedded with watermarking information by the smart phone.

“Digital watermarking image code” (also called “image code”) embeds the website information (or ID information representing the website) in the image by using the digital watermarking technology, and meanwhile through taking pictures of the printed image embedded with watermarking information by the smart phone (or image displayed on the electronic screen), the website information embedded in the image can be detected, so that the mobile phone automatically connects to the site of the website. Compared with the traditional two-dimensional code, the digital watermarking image code cannot only ensure the integrity of the image, but also can be used as two-dimensional code, so that it has more personalized space and great market potential.

However, in order to take pictures and read the watermarking information in the image printed on the paper (or displayed on the electronic screen) by the smart phone, three kinds of distortions caused by the picture taken by the smart phone camera should be overcome first, (1) the image disproportions due to the uncertainty of the distance between the mobile phone and the image; (2) the rotation of the angle of the image due to the uncertainty of the horizontal angle between the mobile phone camera and the image; (3) the image form deformation due to the disalignment of the mobile phone camera surface and the image surface. Therefore, how to identify the watermarking information of the printed image quickly and accurately has become the key bottle neck technology for the replacement of two-dimensional code by image code.

So that in view of the above-mentioned drawbacks of the prior art, it is necessary to conduct a study to provide a solution to the drawbacks of the prior art.

### SUMMARY

In order to overcome the drawbacks of the prior art, the present invention provides an image code applicable for quick image identification in the hand-held communication device and a method of generating and analyzing the same, to solve the above-mentioned issues.

In order to solve the existing issues in the prior art, the technical scheme is:

an image code for information processing, the image code comprises a standard image region, at least one image filled in the standard image region, at least one segment of information stream embedded in the at least one image by using the digital watermarking technology and 4 location identification graphics arranged in different positions of the standard image region, the location identification graphics are arranged in the 4 vertex angles of the standard image region, including 1 feature location identification graphic and 3 basic location identification graphics; the 3 basic location identification graphics are identical and the feature location identification graphic is different from the basic location identification graphic, the location identification graphic includes a dark central part, a white inner ring, a dark ring and a white outer ring, wherein the area of the dark central part of the basic location identification graphic is different from that of the feature location identification graphic.

Preferably, the location identification graphic comprises a dark central part, a white inner ring, a dark inner ring, and a white outer ring, wherein the area of the dark central part of the basic location identification graphic is different from that of the dark central part of the feature location identification graphic.

Preferably, the location identification graphic is a square region, in which a dark central part, a white inner ring, a dark inner ring and a white outer ring are all square regions, the dark central part and the dark inner ring are black central part and black inner ring;

The horizontal characteristic scale and the vertical characteristic ratio of the basic location identification graphic segmented by each part are 1:1:1:3:1:1:1, respectively; the horizontal characteristic scale and the vertical characteristic ratio of the feature location identification graphic are 1:1:1:1:1:1:1, respectively.

Preferably, the standard image region is a square region.

The present invention also discloses an image code apparatus for information storage, transfer and identification, the image code apparatus for information storage, transfer and identification comprises:

an image adjusting module, the image adjusting module is used to adjust images associated with the information to be embedded to fit the standard image region;

a digital watermarking embedding module, the digital watermarking embedding module embeds the information to be embedded in the image by using the digital watermarking encoding technology;

a location identification setting module, the location identification setting module is used to place 4 location identification graphics (P0, P1, P2, P3) in the 4 vertex angles of the standard image region respectively, wherein comprising 1 feature location identification graphic (P3) and 3 basic location identification graphics (P0, P1, P2); the 3 basic location identification graphics (P0, P1, P2) are identical and are different from the feature location identification graphic (P3); and

an image code generating module, the image code generating module is used to synthesize the watermarking information, the image and the location identification graphic to generate the image code.

The present invention also discloses a method of generating an image code, comprising the following steps:

(1) provides an image adjusting module to adjust images associated with the information to be embedded to fit the standard image region;

(2) provides a digital watermarking embedding module to embed the information to be embedded in the image by using the digital watermarking coding technology;

(3) provides a location identification setting module to place 4 location identification graphics (P0, P1, P2, P3) in the 4 vertex angles of the standard image region respectively, wherein comprising 1 feature location identification graphic (P3) and 3 basic location identification graphics (P0, P1, P2); the 3 basic location identification graphics (P0, P1, P2) are identical and are different from the feature location identification graphic (P3); and

(4) provides an image code generating module to generate an image code.

Preferably, the embedded location identification graphics in the step (3) include a dark central part, a white inner ring, a dark inner ring and a white outer ring, wherein the horizontal characteristic scale and the vertical characteristic ratio of the basic location identification graphic segmented by the parts are 1:1:1:3:1:1:1, respectively; the horizontal characteristic scale and the vertical characteristic ratio of the feature location identification graphics are 1:1:1:1:1:1, respectively; wherein the side length of the basic location identification graphics and the feature identification graphics both are 1/10 to ¼ of the side length of the image.

Preferably, it further includes a step of registering the information to be embedded in the server database before generating the image code.

The present invention also discloses an apparatus of analyzing an image code for information storage, transfer and identification, the apparatus of analyzing an image code for information storage, transfer and identification comprises:

an image acquiring apparatus, the image acquiring apparatus is used for acquiring image code (called “acquired image” below);

an image processing module, the image processing module is used for performing image processing on the acquired image;

a location identification graphic positioning module, the location identification graphic positioning module is used for positioning the 4 location identification graphics in the acquired image and identifying the feature location identification graphic;

a calculating module, the calculating module is centered on the feature location identification graphic and calculates the location coordinates of the 3 basic location identification graphics according to the location relationship with the 3 basic location identification graphics in the acquired image;

an image correcting module, the image correcting module corrects the acquired image to the standard image format by the Perspective Transform and the Bilinear Interpolation principle of coordinates; and

an information decoding module, the information decoding module acquires the information embedded in the standard image by using the digital watermarking decoding technology.

The present invention also discloses a method of analyzing an image code, comprising the following steps:

(1) provides an image acquiring apparatus to acquire the image code (called “acquired image” below);

(2) provides an image processing module to perform image processing on the acquired image;

(3) provides a location identification graphic positioning module to position the 4 location identification graphics in the acquired image and identify the feature location identification graphic;

(4) provides a calculating module, which is centered on the feature location identification graphic and calculates the location coordinates of the 3 basic location identification graphics according to the location relationship with the 3 basic location identification graphics in the acquired image;

(5) provides an image correcting module to correct the acquired image to the standard image format by the Perspective Transform and the Bilinear Interpolation principle of coordinates; and

(6) provides an information decoding module to acquire the information embedded in the standard image by using the digital watermarking decoding technology.

Preferably, the step (5) further includes:

(a) the location coordinates pi′(xi, yi) (0≦i≦3) of 4 sets of the location identification graphics in the acquired image and the location coordinates pi(xi, yi) (0≦i≦3) (0≦xi≦255,0≦yi≦255) of 4 sets of the vertex angles in the corrected standard image are substituted into the following formula 1 to obtain the 8 parameter values of a, b, c, d and m, n, p, q;

$$\{ \begin{matrix}{x}_{i}^{′} = {ax}_{i} + {by}_{i} + {cx}_{i} {y}_{i} + d ( 0 \leq i \leq 3 ) \\ {y}_{i}^{′} = {mx}_{i} + {ny}_{i} + {px}_{i} {y}_{i} + q ( 0 \leq i \leq 3 )\end{matrix} \qquad Formula ( 1 )$$

(b) the coordinate values (0≦xi≦255, 0≦yi≦255) of the corrected image are substituted into formula 1 to calculate the corresponding coordinate values (xi′, yi′) of the image before correction;

(c) according to the adjacent relationship of the coordinate values shown in FIG. 10, 4 coordinate values (x0′, y0′), (x0′, y1′), (x1′, y0′), (x1′, y1′) are calculated from the coordinate values (xi′, yi′) rounding upwards and downwards by using the Bilinear Interpolation principle of coordinates;

(d) the image pixel values f(x0′, y0′), f(x0′, y1′), f(x1′, y0′), f(x1′, y1′) of the 4 coordinate values (x0′, y0′), (x0′, y1′), (x1′, y0′), (x1′, y1′) after the Bilinear Interpolation calculation are substituted into the following formula 2 to obtain the image pixel values f(xi, yi)(0≦xi≦255, 0≦yi≦255) after the Perspective Transform;

f(xᵢ,yᵢ)=[f(x₁′,y₀′)−f(x₀′,y₀′)]×(x₁′−x₀′)+[f(x₀′,y₁′)−f(x₀′,y₀′)]×(y₁′−y₀′)+[f(x₁′,y₁′)+f(x₀′,y₀′)−f(x₀′,y₁′)−f(x₁′,y₀′)]×(x₁′−x₀′)×(y₁′−y₀′)+f(x₀′,y₀′) Formula (2)

(e) repeats steps (b) to (d) to obtain the all image pixels values f(xi, yi)(0≦xi≦255, 0≦yi≦255) of corrected standard image.

Preferably, the step (3) identifies the feature location identification graphic by calculating and comparing the area of the dark central part of the 4 location identification graphics.

Compared with the prior art, through adopting the scheme of the present invention, it is possible to quickly acquire the information in the image code through the hand-held communication device and to realize the fast link between the hand-held communication device and the Internet by using the image (graphic) own content, and compared with the two-dimensional code in the prior art, it has the following advantages: the image code is more beautiful and can display the information content intuitively; the content information is more secure and difficult to be tampered with or forged; and the 4 positioning points adopted by the invention consist of 3 identical and 1 different positioning points, with the use of the Perspective Transform, the correction of the rotation of the angle within the 360-degree, the correction of the form deformation of the mobile phone image and the disproportions can be completed simultaneously.

### BRIEF DESCRIPTION OF THE DRAWINGS

FIG. 1 is a structural block diagram of the image code of the present invention;

FIG. 2 is a detailed structural diagram of the basic location identification graphic in FIG. 1.

FIG. 3 is a detailed structural diagram of the feature location identification graphic in FIG. 1;

FIG. 4 is a block diagram of the principle of an apparatus for generating an image code according to the present invention;

FIG. 5 is a flow diagram of a method of generating an image code according to the present invention;

FIG. 6 is an apparatus for analyzing an image code according to the present invention;

FIG. 7 is a flow diagram of a method of analyzing an image code according to the present invention;

FIG. 8 is a schematic diagram of the acquired image after the binarization processing;

FIG. 9 is a schematic diagram of the principle of the Perspective Transform;

FIG. 10 is a diagram of the Bilinear Interpolation principle of coordinates;

FIG. 11 is a schematic diagram of the decoding process of the digital watermarking information.

### DETAILED DESCRIPTION

In order that the objectives, technical schemes and advantages of the present invention will become more apparent, the present invention will be described in more detail with reference to the drawings and examples above. It should be understood that the specific embodiments described herein are only for illustrating but not for limiting the present invention.

On the contrary, the invention is intended to cover any alternatives, modifications, equivalent methods and solutions falling within the spirit and scope of the invention as defined by the claims. Furthermore, in order to provide a better understanding of the present invention, specific details will be described in detail in the following detailed description of the present invention. The present invention may also be fully understood by those skilled in the art without a detailed description of these details.

In the hand-held communication device, the identification image code is much restricted by its own resources, mainly in the following technical problems: (1) the image disproportions due to the uncertainty of the distance between the mobile phone and the image; (2) the rotation of the angle of the image due to the uncertainty of the horizontal angle between the mobile phone camera and the image; (3) the image form deformation due to the disalignment of the mobile phone camera surface and the image surface. The above technical problem causes the hand-held communication device to have the problems of slow processing speed and high misrecognition rate when recognizing the image code, which greatly affect the practical application of the image code. It will be appreciated that the hand-held communication device is a device having an image acquiring apparatus (e.g., CCD) and communicable with the Internet (e.g., through wifi, bluetooth, cellular network, etc.), including mobile phone, Ipad, camera with communication function, e-books and other similar electronic devices.

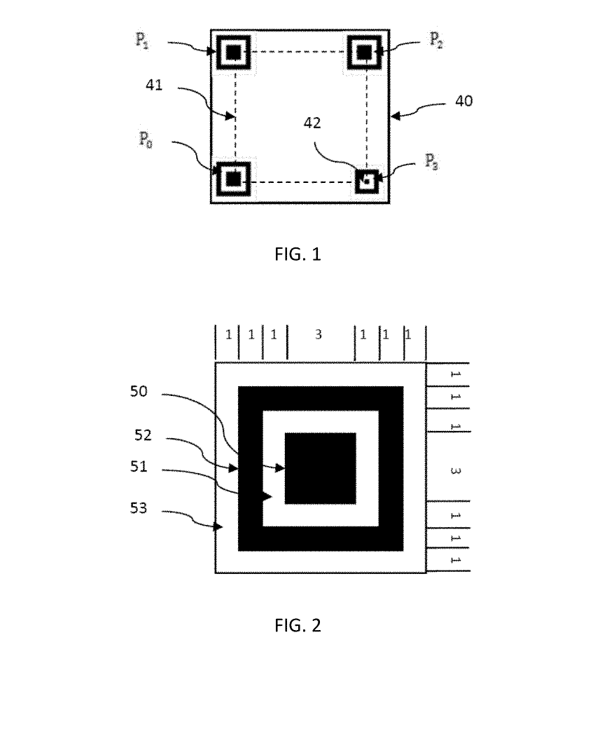

In order to realize quick identification of an image code of a printed image (including an electronic screen display) in a hand-held communication device, the present invention proposes an image code for information storage, transfer and identification, which is usually printed on a surface of a carrier (the carrier includes paper, plastic, metal, fabric, building, etc.), or displayed on an electronic screen. Refer to FIG. 1, it illustrates a structural block diagram of an image code of the present invention, including a standard image region (40), at least one image filled in the standard image region (40). The image is typically a non-black-and-white square image, including company identification, photographs, and the like. At least one segment of information stream embedded in the at least one image by using the digital watermarking technology, and 4 location identification graphics arranged at different positions of the standard image region (40).

The standard image region (40) is used to fill the image and embed the information to be embedded in the image by using the digital watermarking technology; in a preferred embodiment, the standard image region (40) is a square region. The shape of the outer contour of the image is not limited, but may be a square shape, a circular shape having a regular shape, or an irregular shape.

The location identification graphic is used for positioning of the image code and is provided at the 4 vertex angles of the standard image region, and the location identification graphic includes 1 feature location identification graphic and 3 location identification graphics. The 3 basic location identification graphics are identical and the feature location identification graphic is different from the basic location identification graphics. Typically, the area of the feature location identification graphic is smaller than the basic location identification graphic. As illustrated in FIG. 1, wherein (40) is a standard image region surrounded by the image frame position; (P0), (P1), (P2), (P3) are the location identification graphics of No. 0-3 (P0,P1,P2,P3) respectively; (P0), (P1), (P2) are the basic location identification graphics, (P3) is the feature location identification graphics; the frames of the images of (P0), (P1), (P2) align with the frames of the standard image region (40) of the 3 vertex angles of the image; the dotted line (41) is a square connecting line formed by connecting the 3 central point coordinates of (P0), (P1) and (P2); (P3) is placed at the 4th vertex angle position so that the center point of (P3) is moved to the vertex angle position (42) of the square dotted line (41).

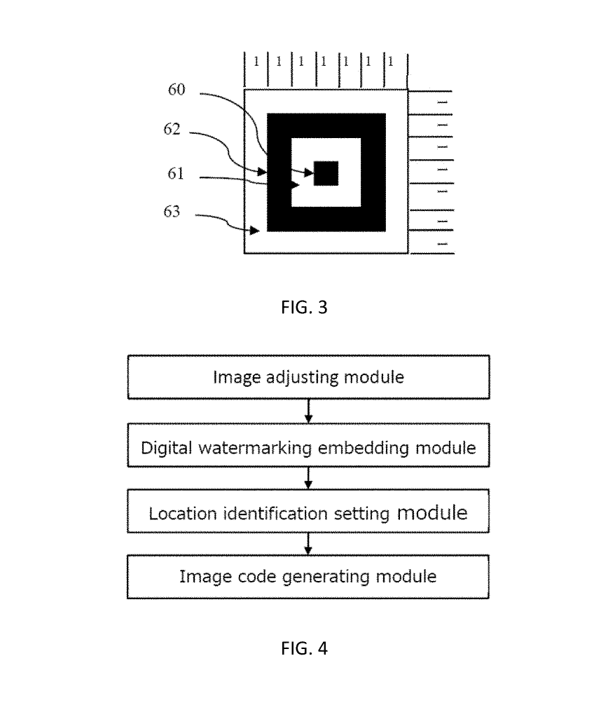

Refer to FIG. 2 and FIG. 3. they are detailed structural diagrams of the location identification graphics. The location identification graphic comprises a dark central part, a white inner ring, a dark inner ring, and a white outer ring, wherein the area of the dark central part of the basic location identification graphic is different from that of the dark central part of the feature location identification graphic. In one preferable embodiment, the location identification graphic is a square region, in which the dark central part, the white inner ring, the dark inner ring and the white outer ring are also square regions, the dark central part and the dark inner ring are black central part and black inner ring; refer to FIG. 2, it illustrates the detailed structural diagram of the basic location identification graphic, (50) is the black central part; (51) is the white inner ring; (52) is the black inner ring; (53) is the white outer ring. Wherein the color of the black part can also be dark colors other than black; the shapes of (50) (51) (52) and (53) can also be shapes other than square. The horizontal characteristic scale and the vertical characteristic ratio segmented by the each part are 1:1:1:3:1:1:1, respectively. Wherein, the side length of the basic location identification graphic is 1/10 to ¼ of the side length of the image.

Refer to FIG. 3, it illustrates the detailed structural diagram of the basic location identification graphic, similar to FIG. 2, wherein, (60) is the black central part; (61) is the white inner ring; (62) is the black inner ring; (63) is the white outer ring. Wherein the color of the black part can also be dark colors other than black; the shapes of (60) (61) (62) and (63) can also be shapes other than square. The difference is that the horizontal characteristic scale and the vertical characteristic ratio are 1:1:1:1:1:1:1, respectively. Wherein, the side length of the feature location identification graphic is 1/10 to ¼ of the side length of the image.

In the existing two-dimensional code technology, 3 identical positioning points are usually used in conjunction with the two-dimensional code frame to correct the image. Wherein the identification of 3 identical positioning points can be done only by 2D Affine Transform to make the angle correction of the image within 360-degree range, to perform correction of the image form deformation through the Perspective Transform, it is necessary to calculate the 4 intersections of 4 border lines by identifying the 4 border lines of the image. Therefore, when the two-dimensional code area is non-black-and-white square and has no regular frame, it can not correct the image form deformation by the 3 positioning points themselves. Meanwhile, the patent application CN 103632182 A proposes a method of correcting an image by using 4 identical positioning points, although this method can correct the angle of the image and the deformation of the form by the Perspective Transform, since the 4 identical positioning marks are used, the correction can only be limited to angles within 90 degrees (between −45 degrees and +45 degrees). The 4 positioning points adopted in the image code embedded with watermarking information provided by the present invention consist of 3 identical basic location identification graphics and one different feature location identification graphic, which can position the feature location identification graphic quickly, through the Perspective Transform, the correction of the form deformation, the disproportions and the rotation of angle within 360-degree range of the mobile phone image can be made simultaneously. That is, the image code provided by the present invention can be identified by the hand-held communication device quickly and accurately, so that the watermarking technology can be applied in the image code successfully.

The present invention also provides an apparatus of generating an image code for information storage, transfer and identification, refer to FIG. 4, it illustrates the block diagram of the principle of the apparatus of generating an image code for information storage, transfer and identification, mainly including an image adjusting module, a digital watermarking embedding module, a location identification setting module and an image code generating module, wherein

the image adjusting module is used for adjusting the image associated with the information to be embedded to fit the standard image region; the standard image region (40) in the image code is a predefined image format, it is needed to adjust the image to the corresponding image format through the image adjusting module before the image is filled in the standard image region (40).

The digital watermarking embedding module is used for embedding the information to be embedded in the image by using the digital watermarking encoding technology; the digital watermarking encoding technology is a mature image coding technology in prior art, by which the digital information can be embedded in the image without damaging the original image.

The location identification setting module is used for placing 4 location identification graphics (P0, P1, P2, P3) in the 4 vertex angles of the standard image area respectively, wherein comprising 1 feature location identification graphic (P3) and 3 basic location identification graphics (P0, P1, P2); the 3 basic location identification graphics (P0, P1, P2) are identical and are different from the feature location identification graphic (P3); and

the image code generating module is used for synthesizing the watermarking information, the image and the location identification graphic to generate the image code.

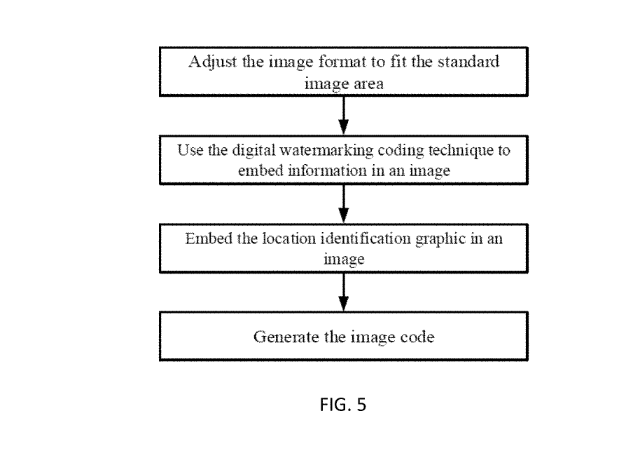

The present invention also provides a method of generating an image code, refer to FIG. 5, it illustrates the flow diagram of the method of generating an image code in the present invention, the specific steps are:

(1) provides an image adjusting module to adjust images associated with the information to be embedded to fit the standard image region; generally, the selected image is associated with the information to be embedded. In order to facilitate the image processing, the image format is adjusted to just fit the agreed standard image region. In the preferable implementation, the standard image region is a square image region.

(2) provides a digital watermarking embedding module to embed the information to be embedded in the image by using the digital watermarking coding technology;

(3) provides a location identification setting module to place 4 location identification graphics (P0, P1, P2, P3) in the 4 vertex angles of the standard image region respectively, wherein comprising 1 feature location identification graphic (P3) and 3 basic location identification graphics (P0, P1, P2); the 3 basic location identification graphics (P0, P1, P2) are identical and are different from the feature location identification graphic (P3); and (4) provides an image code generating module to generate an image code.

The image code generated by the image code generating apparatus and method adopted the above technical scheme consists of 3 identical basic location identification graphics and one different feature location identification graphic, so that the feature location identification graphic can be quickly positioned when the mobile phone processes the image code, using the Perspective Transform to complete the correction of the rotation of the angle within 360-degree range, as well as the correction of the form deformation and the disproportions of the mobile phone image.

The storage information amount in the image code is limited, when the information amount embedded in the image code is large, in order to make the image code carry more information, in one preferable embodiment of the invention, it further includes a step of registering the information to be embedded in the server database before generating the image code. That is, embedding the representative website ID information in the image, and registering the website ID information and the website information in the server database; correspondingly, the website information can be found in the server database by using the acquired website ID information at the time of decoding.

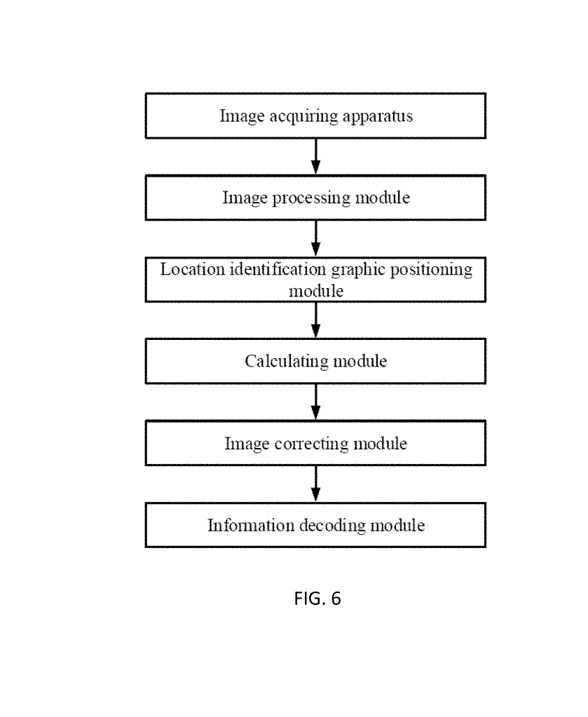

The present invention also provides an apparatus of analyzing an image code for information storage, transfer and identification. The apparatus is hand-held communication device. The hand-held communication device is a device having an image acquiring apparatus (e.g., CCD) and communicable with the Internet (e.g., through wifi, bluetooth, cellular network, etc.), including mobile phone, Ipad, camera with communication function, e-books and other similar electronic devices. Refer to FIG. 6, it illustrates the block diagram of the principle of the apparatus of analyzing an image code for information storage, transfer and identification, including an image acquiring apparatus, an image processing module, a location identification graphic positioning module, a calculating module, an image correcting module and an information decoding module, wherein:

the image acquiring apparatus is used for acquiring image code (called “acquired image” below);

the image processing module is used for performing image processing on the acquired image code image;

the location identification graphic positioning module is used for positioning the 4 location identification graphics in the acquired image and identifying the feature location identification graphic;

the calculating module is used for being centered on the feature location identification graphic and calculating the location coordinates of the 3 basic location identification graphics according to the location relationship with the 3 basic location identification graphics in the acquired image;

the image correcting module is used for correcting the acquired image code image to the standard image format by the Perspective Transform and the Bilinear Interpolation principle of coordinates; and

the information decoding module is used for acquiring the information embedded in the standard image by using the digital watermarking decoding technology.

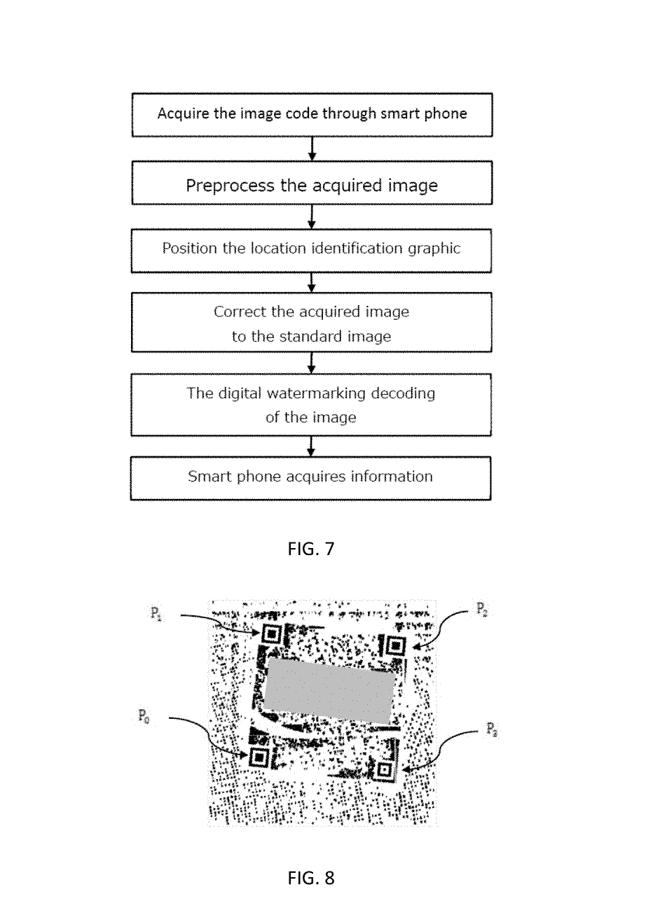

The present invention also proposes a method of analyzing an image code, refer to FIG. 7, it illustrates the flow diagram of the method of analyzing an image code in the present invention, the specific steps are:

(1) provides an image acquiring apparatus to acquire an image code (called “acquired image” below), the image code is acquired by hand-held communication device; uses the camera of the hand-held communication device to take pictures of the image code displayed on the electronic screen or printed on the paper or directly import the image code image into the hand-held communication device, and generates an image code image.

(2) provides an image processing module to perform image processing on the acquired image; performs image processing on the generated image code image; the image code image is converted to a gray-scale image of 256 gray-scale first, and then use the Niblack method to do the binarization processing on the image.

(3) provides a location identification graphic positioning module to position the 4 location identification graphics in the actual image and identify the feature location identification graphic; the 4 location identification graphics are identified in the binarized image and the coordinate values of the 4 location detection graphics are calculated; due to it is composed of 3 identical basic location identification graphics and one different feature location identification graphics, so that it can position the feature identification graphic quickly.

Wherein, the feature location identification graphic is identified by calculating and comparing the area of the dark central part of the 4 location identification graphics, the specific steps are as follows, calculating the areas of the black portion in the central part of the 4 location detection graphics and comparing the areas of the black portion in the central part of the 4 location detection graphics, to find out the location identification graphic, in which the area of the black portion is different from the other three graphics, as illustrated in FIG. 8, wherein the No. 3 location identification graphic is the feature identification graphic and its location coordinate is calculated. In one preferable embodiment, the area of the black proportion in the central part of the feature location identification graphic is 1/9 of the area of the black proportion in the central part of the basic location identification graphic.

(4) provides a calculating module, which is centered on the feature location identification graphic and calculates the location coordinates of the 3 basic location identification graphics according to the location relationship with the 3 basic location identification graphics in the actual image.

(5) provides an image correcting module to correct the acquired image to the standard image format by the Perspective Transform and the Bilinear Interpolation principle of coordinates; that is, obtains the standard image through the Perspective Transform (the following formula 1) and the Bilinear Interpolation principle of coordinates (the following formula 2).

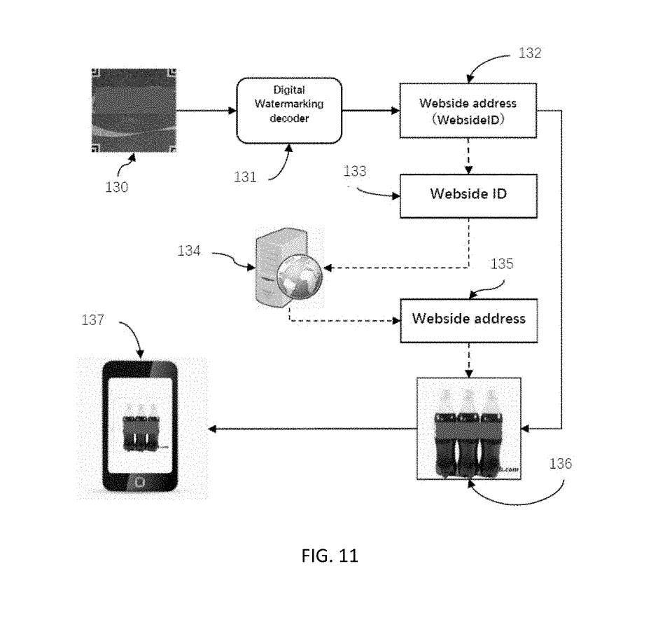

(6) provides an information decoding module to acquire the information embedded in the standard image by using the digital watermarking decoding technology. Refer to FIG. 11, it illustrates the schematic diagram of the decoding process of the digital watermarking information, using the information (132) detected in the corrected image (130) by the digital watermarking decoder (131); if the detected information is the website ID information registered in the server, the corresponding website information can be searched out through the server database; the corresponding web page (136) is displayed on the screen (137) of the hand-held communication device through the detected (or searched out) website information.

In one preferable embodiment, the step (5) further includes:

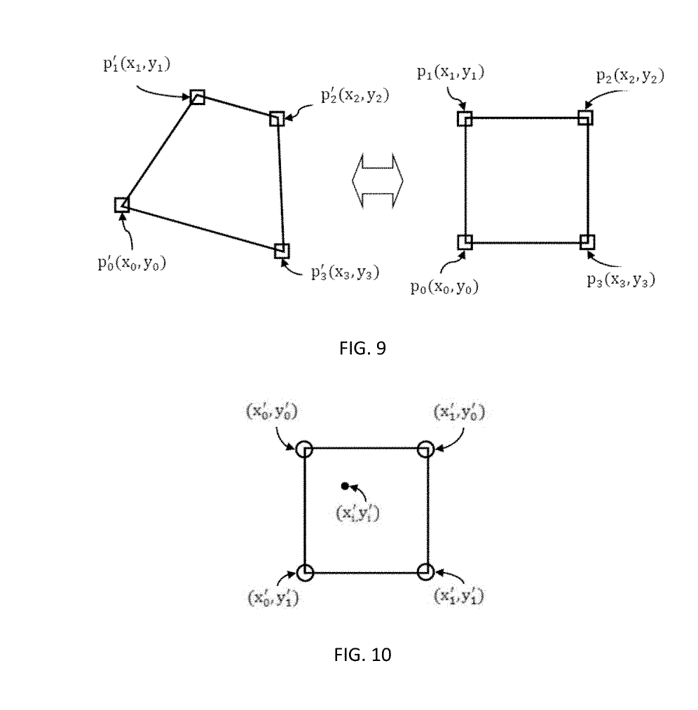

(a) the location coordinates pi′ (xi, yi) (0≦i≦3) of 4 sets of the location identification graphics in the acquired image and the location coordinates pi (xi, yi) (0≦i≦3) (0≦xi≦255,0≦yi≦255) of 4 sets of the vertex angles in the corrected standard image are substituted into the following formula 1 to obtain the 8 parameter values of a, b, c, d and m, n, p, q; refer to FIG. 9, it illustrates the diagram of the principle of the Perspective Transform, wherein pi′ (xi, yi) (0≦i≦3) is the coordinate value of the central point of the 4 location identification graphics in the image including form deformation, rotation and scaling; pi (xi, yi) (0≦i≦3) is the coordinate value of the central point of the 4 location identification graphics in the standard image after the Perspective Transform; the relationship between pi′ (xi, yi) (0≦i≦3) and pi (xi, yi)(0≦i≦3) can be expressed by the following formula 1.

yi′=mxi+nyi+pxiyi+q (0≦i≦3)

xi′=axi+byi+cxiyi+d (0≦i≦3) Formula (1)

The 8 parameters a, b, c, d and m, n, p, q in formula 1 can be obtained by substituting the 8 sets of data, pi′ (xi, yi) (0≦i≦3) and pi (xi,yi) (0≦i≦3) in formula 1.

(b) the coordinate values (0≦xi≦255, 0≦yi≦255) of the corrected image are substituted into formula 1 to calculate the corresponding coordinate values (xi′, yi′) of the image before correction;

(c) according to the adjacent relationship of the coordinate values shown in FIG. 10, 4 coordinate values (x0′, y0′), (x0′, yl′), (xl′, y0′), (xl′, yl′) are calculated from the coordinate values (xi′, yi′) rounding upwards and downwards; refer to FIG. 10, it illustrates the diagram of the Bilinear Interpolation principle of coordinates. Wherein the small round black spot (xi′, yi′) is the coordinate value of the image before correction calculated by formula 1; the coordinate values (x0′, y0′), (x0′, y1′), (x1′, y0′), (x1′, y1′) of the 4 small circles are the coordinate values of the floating decimal (xi′, yi′) after rounding; wherein x0 ‘and x1’ are the integers with the decimal points of xi′ downwards and upwards respectively (0′≦xi′≦x1′); y0′ and y1′ are the integers with the decimal points of yi′ downwards and upwards respectively (0′≦yi′≦y1′).

(d) the image pixel values f(x0′, y0′), f(x0′, y1′), f(x1′, y0′), f(x1′, y1′) of the 4 coordinate values (x0′, y0′), (x0′, y1′), (x1′, y0′), (x1′, y1′) after the Bilinear Interpolation calculation are substituted into formula 2 to obtain the image pixel values f(xi, yi) (0≦xi≦255, 0≦yi≦255) after the Perspective Transform;

f(xᵢ,yᵢ)=[f(x₁′,y₀′)−f(x₀′,y₀′)]×(x₁′−x₀′)+[f(x₀′,y₁′)−f(x₀′,y₀′)]×(y₁′−y₀′)+[f(x₁′,y₁′)+f(x₀′,y₀′)−f(x₀′,y₁′)−f(x₁′,y₀′)]×(x₁′−x₀′)×(y₁′−y₀′)+f(x₀′,y₀′) Formula (2)

(e) repeats steps (b) to (d) to obtain the all image pixels values f(xi, yi)(0≦xi≦255, 0≦yi≦255) of corrected standard image.

The foregoing is only preferred exemplary embodiments of the present invention and is not intended to be limiting of the present invention, and any modifications, equivalent substitutions, improvements and the like within the spirit and principles of the present invention are intended to be embraced by the protection range of the present invention.

What is claimed is:

1. A system for information processing comprises an image code and an image code apparatus for information storage, transfer and identification, the characterized in that the image code comprises a standard image region, at least one image filled in the standard image region, at least one segment of information stream embedded in the at least one image by using digital watermarking technology and 4 location identification graphics arranged in different positions of the standard image region, the location identification graphics are arranged in 4 vertex angles of the standard image region, including 1 feature location identification graphic and 3 basic location identification graphics; the 3 basic location identification graphics are identical and the feature location identification graphic is different from the basic location identification graphic, the location identification graphic includes a dark central part, a white inner ring, a dark ring and a white outer ring, wherein the area of the dark central part of the basic location identification graphic is different from that of the feature location identification graphic.

2. The system according to claim 1, characterized in that the location identification graphic is a square region, in which a dark central part, a white inner ring, a dark inner ring and a white outer ring are all square regions, the dark central part and the dark inner ring are black central part and black inner ring;
the horizontal characteristic scale and the vertical characteristic ratio of the basic location identification graphic segmented by each part are 1:1:1:3:1:1:1, respectively; the horizontal characteristic scale and the vertical characteristic ratio of the feature location identification graphic are 1:1:1:1:1:1:1, respectively.

3. The system according to claim 1, the image code apparatus for information storage, transfer and identification comprises:
an image adjusting module, the image adjusting module is used to adjust images associated with the information to be embedded to fit the standard image region;
a digital watermarking embedding module, the digital watermarking embedding module embeds the information to be embedded in the image by using digital watermarking encoding technology;
a location identification setting module, the location identification setting module is used to place 4 location identification graphics (P0, P1, P2, P3) in the 4 vertex angles of the standard image region respectively, wherein comprising 1 feature location identification graphic (P3) and 3 basic location identification graphics (P0, P1, P2); the 3 basic location identification graphics (P0, P1, P2) are identical and are different from the feature location identification graphic (P3); and
an image code generating module, the image code generating module synthesizes the watermarking information, the image and the location identification graphic to generate the image code.

4. The system according to claim 1, the image code is generating by the following steps:
provides an image adjusting module to adjust images associated with the information to be embedded to fit the standard image region;
provides a digital watermarking embedding module to embed the information to be embedded in the image by using digital watermarking coding technology;
provides a location identification setting module to place 4 location identification graphics (P0, P1, P2, P3) in the 4 vertex angles of the standard image region respectively, wherein comprising 1 feature location identification graphic (P3) and 3 basic location identification graphics (P0, P1, P2); the 3 basic location identification graphics (P0, P1, P2) are identical and are different from the feature location identification graphic (P3); and
provides an image code generating module to generate image code.

5. The method according to claim 4, characterized in that in the step (3), the embedded location identification graphic includes a dark central part, a white inner ring, a dark inner ring and a white outer ring, wherein the horizontal characteristic scale and the vertical characteristic ratio of the basic location identification graphic segmented by the parts are 1:1:1:3:1:1:1, respectively; the horizontal characteristic scale and the vertical characteristic ratio of the feature location identification graphics are 1:1:1:1:1:1.

6. The method according to claim 5, characterized in that it further comprises a step of registering the information to be embedded in the server database before generating the image code.

7. An apparatus of analyzing image code for information storage, transfer and identification, characterized in that the apparatus of analyzing image code for information storage, transfer and identification comprises:
an image acquiring apparatus, the image acquiring apparatus is used for acquiring image code (called “acquired image” below);
an image processing module, the image processing module is used for performing image processing on the acquired image;
a location identification graphic positioning module, the location identification graphic positioning module is used for positioning the 4 location identification graphics in the acquired image and identifying the feature location identification graphic;
a calculating module, the calculating module is centered on the feature location identification graphic and calculates the location coordinates of the 3 basic location identification graphics in the acquired image according to the location relationship with the 3 basic location identification graphics in the actual image;
an image correcting module, the image correcting module corrects the image code image to the standard image format by the Perspective Transform and the Bilinear Interpolation principle of coordinates; and
an information decoding module, the information decoding module acquires the information embedded in the standard image by using the digital watermarking decoding technology.

8. A method for analyzing an image code, characterized by comprising the following steps:
(1) provides an image acquiring apparatus to acquire image code (called “acquired image” below);
(2) provides an image processing module to perform image processing on the acquired image;
(3) provides a location identification graphic positioning module to position the 4 location identification graphics in the actual acquired image and identify the feature location identification graphic;
(4) provides a calculating module, which is centered on the feature location identification graphic and calculates the location coordinates of the 3 basic location identification graphics according to the location relationship with the 3 basic location identification graphics in the acquired-image;
(5) provides an image correcting module to correct the acquired image to the standard image format by the Perspective Transform and the Bilinear Interpolation principle of coordinates; and
(6) provides an information decoding module to acquire the information embedded in the standard image by using the digital watermarking decoding technology.

9. The method according to claim 8, characterized in that the step (5) further comprises:
(a) the location coordinates pi′ (xi, yi) (0≦i≦3) of 4 sets of the location identification graphics in the acquired image and the location coordinates pi (xi, yi) (0≦i≦3) (0≦xi≦255, 0≦yi≦255) of 4 sets of the vertex angles in the corrected standard image are substituted into the following formula 1 to obtain the 8 parameter values of a, b, c, d and m, n, p, q;
$$\{ \begin{matrix}{x}_{i}^{′} = {ax}_{i} + {by}_{i} + {cx}_{i} {y}_{i} + d ( 0 \leq i \leq 3 ) \\ {y}_{i}^{′} = {mx}_{i} + {ny}_{i} + {px}_{i} {y}_{i} + q ( 0 \leq i \leq 3 )\end{matrix} \qquad Formula ( 1 )$$
(b) the coordinate values (0≦xi≦255, 0≦yi≦255) of the corrected imageare substituted into formula 1 to calculate the corresponding coordinate values (xi′, yi′) of the image before correction;
(c) according to the Bilinear Interpolation principle of coordinates, (x0′, y0′), (x0′, yl′), (xl′, y0′), (x1′, y1′) are calculated from the coordinate values (xi′, yi′) rounding upwards and downwards;
(d) the image pixel values f(x0′, y0′), f(x0′, y1′), f(x1′, y0′), f(x1′, y1′) of the 4 coordinate values (x0′, y0′), (x0′, y1′), (x1′, y0′), (x1′, y1′) after the Bilinear Interpolation calculation are substituted into the following formula 2 to obtain the image pixel values f(xi, yi) (0≦xi≦255, 0≦yi≦255) after the Perspective Transform;
f(xᵢ,yᵢ)=[f(x₁′,y₀′)−f(x₀′,y₀′)]×(x₁′−x₀′)+[f(x₀′,y₁′)−f(x₀′,y₀′)]×(y₁′−y₀′)+[f(x₁′,y₁′)+f(x₀′,y₀′)−f(x₀′,y₁′)−f(x₁′,y₀′)]×(x₁′−x₀′)×(y₁′−y₀′)+f(x₀′,y₀′) Formula (2)
(e) repeats steps (b) to (d) to obtain the all image pixels values f(xi, yi)(0≦xi≦255, 0≦yi≦255) of corrected standard image.

10. The method according to claim 9, characterized in that the step (3) identifies the feature location identification graphic by calculating and comparing the area of the dark central parts of the 4 location identification graphics.
